(19) United States
(12) Patent Application Publication
(10) Pub. No.: US 2018/0028395 A1
(43) Pub. Date: Feb. 1, 2018

(54) FACE MASK APPLICATION TOOL

(71) Applicant: Peter Thomas Roth Labs, LLC, New York, NY (US)

(72) Inventors: Noreen Donovan Roth, New York, NY (US); Peter Thomas Roth, New York, NY (US)

(21) Appl. No.: 15/662,141

(22) Filed: Jul. 27, 2017

Related U.S. Application Data
(60) Provisional application No. 62/367,759, filed on Jul. 28, 2016.

(51) Int. Cl. A61H 7/00; A46B 5/02; A46B 9/02

(52) U.S. Cl. CPC A61H 7/003; A46B 9/026; A46B 5/02; A46B 9/021; A46B 2200/102; A46B 2200/1046

(57) ABSTRACT

The disclosure provides a cosmetic application tool including a top-face having a brush and a bottom-face having a flat and wide portion. The application tool applies skin care product onto an anatomical area to be treated, such as the face. The application tool is formed of a silicone material resistant to microbial contamination, capable of conforming to the contours of the face, and easily cleaned by rinsing with water.

### CROSS-REFERENCE TO RELATED APPLICATIONS

This application claims priority to U.S. provisional patent application No. 62/367,759, filed on Jul. 28, 2016, the contents of which are incorporated herein by reference in their entirety.

### TECHNOLOGY FIELD

The present disclosure relates to a device that is intended to apply skin care product to an anatomical area to be treated.

### BACKGROUND

Currently, the application of skin care products to the skin surface has varying techniques which may depend upon the skin care product composition and a user's preferences. For instance, the skin care product composition may be in liquid form or paste form. In addition, the method by which the product is uniformly applied and effectively used to treat the application areas varies. For example, the method of applying skin care product in paste form may simply require a user's fingers to gently massage the product onto the skin surface. This method however, because of the use of fingers, may cause the product to be contaminated for future subsequent use. Therefore, an appropriate application tool is desirable.

### SUMMARY

The present disclosure provides a device for applying skin care product to an anatomical area to be treated, such as the face. In particular, the present disclosure is directed to a face mask application tool for a uniform and effective application of a product, such as a skin rejuvenation product for example, to the skin surface of the face.

In embodiments, the disclosure provides an application tool made of silicone material, which is resistant to microbial contamination. Skin care products are able to be placed on and removed from the silicone material when transferring the product from a product container to a treatment area, such as the face of the user. The silicone material may be effectively cleaned by rinsing the application tool with water. The application tool has a brush (or bristles) portion and a bottom portion having a wide and flat area.

In embodiments, the application tool may be used to scoop or otherwise remove skin care product from a product container. Having the product transferred directly on the application tool prevents contamination of the product for future use. Using an application area of the application tool, the product may be applied to the treatment areas. Once the product has been uniformly applied, the user may gently massage the product into the skin. The top portion of the application tool having a brush (or bristles) portion may be used to effectively massage the product into the treatment areas of the skin surface and/or subsurface of the face. The brush portion enhances the skin's ability to absorb active ingredients of the skin care product to the surface and/or subsurface, thereby maximizing the cosmetic formula effectiveness of the product.

The application tool, having soft silicone, contours to the skin profile to effectively and gently remove excess product from the skin.

### BRIEF DESCRIPTION OF THE DRAWINGS

The accompanying drawings, which are incorporated in and constitute a part of this specification, show certain aspects of the subject matter disclosed herein and, together with the description, help explain some of the aspects with the disclosed implementations. In the drawings:

FIG. 1 is a perspective view illustrating a face mask application tool, according to an embodiment;

FIG. 2 is a side view illustrating the face mask application tool of FIG. 1;

FIG. 3 is a top view illustrating the silicone brush (or bristles) portion of the face mask application tool of FIG. 1; and

FIG. 4 is a bottom view illustrating a contoured bottom having a flat and wide portion of the face mask application tool of FIG. 1.

Like reference numerals refer to like parts throughout the several views of the drawings.

### DETAILED DESCRIPTION

The present disclosure provides a device for applying skin care product to an anatomical area to be treated, such as the face. In particular, the present disclosure is directed to a face mask application tool for a uniform and effective application of a product, such as a skin rejuvenation product for example, to the skin surface of the face of a user. The skin care product for use with the disclosed application tool may be of various compositions and forms, such as liquid, gel, paste, or other form.

FIGS. 1-4 illustrate an embodiment of a face mask application tool 101 that includes a top-face 103 having a brush portion 105 (with bristles 105a, 105b) and a bottom-face 115, opposite the top-face 105, having a flat and wide area. The top-face 103, the bottom-face 115, and/or the brush portion 105 may be comprised of a silicone material that is resistant to microbial contamination. The brush portion 105 has a plurality of bristles (for example 105a, 105b). The face mask application tool 101 has, according to an embodiment, a flat or nearly flat top-face surface 103 with a tapered-edge 110 at a proximal end and the brush portion 105 at the distal end of the top-face surface 103.

The face mask application tool 101 has a number of advantages over existing cosmetic tools. In particular, the face mask application tool 101 prevents contamination of skin care product, which traditionally results from multiple uses, by transferring the skin care product directly from a product container (or jar or the like) onto the surface of the skin. In addition, the use of the brush portion of the face mask application tool when applying the skin care product onto the skin ensures active ingredients of the product are absorbed onto the skin surface and sub-surface without contamination. Therefore, use of the application tool may ensure the effectiveness of the skin care product and its integrity for subsequent, future use.

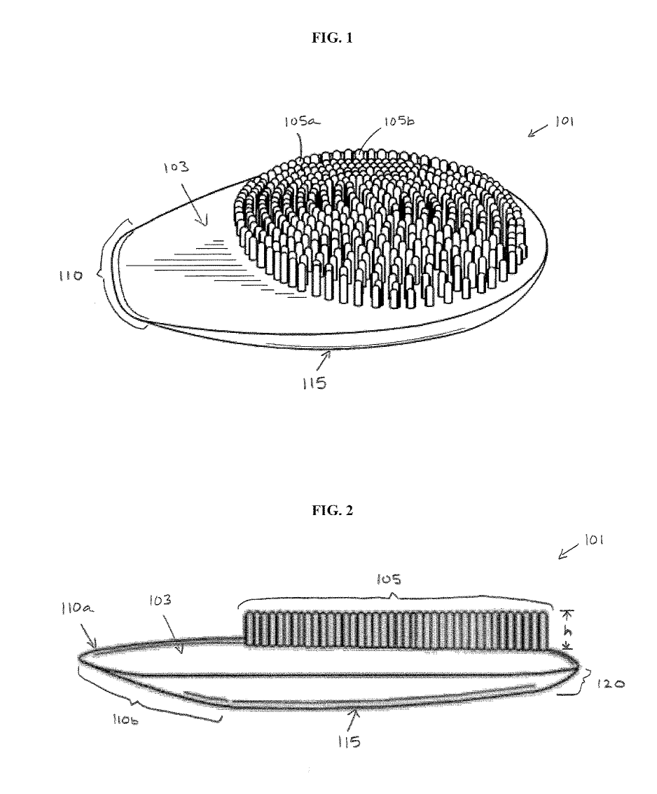

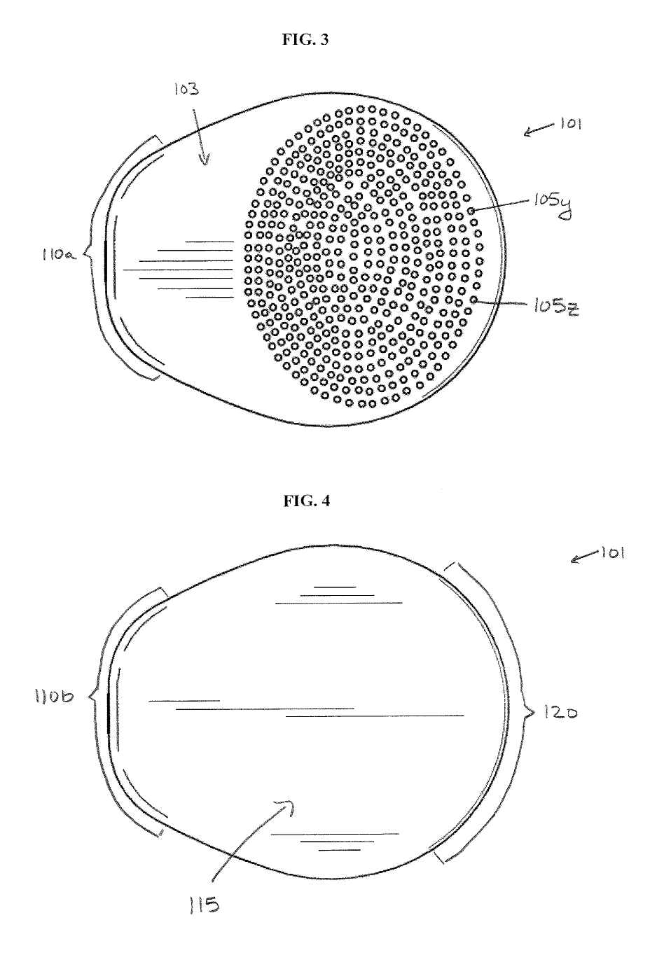

FIG. 2 illustrates a side view of the face mask application tool 101 of FIG. 1. The brush portion 105 on the top-face 103 is comprised of a plurality of bristles (105a, 105b, 105y, and 105z, as shown in FIGS. 1 and 3). The brush portion 105 may have a variety of configurations. For example, the brush portion 105 may have an elliptical configuration (as shown in FIG. 2). In an alternative embodiment, the brush portion 105 may for example have a rectangular, circular, or non-uniform configuration. In addition, the plurality of bristles (105a, 105b . . . , 105y, and 105z) may have a variety of configurations. For example, the bristles shown in FIG. 2 have a uniform height, h. In an alternative embodiment, the bristles may have varying heights such that the skin care product being applied to the skin surface of various portions of the face is optimally absorbed and effective in treating the anatomical area.

The bottom-face 115 of the face mask application tool 101 may be substantially flat. In an embodiment, the bottom-face 115 may have a contoured configuration having a flat and wide surface portion. Along a proximal edge, the bottom-face 115 may have an angled, tapered edge 110b. Along a distal edge, the bottom-face 115 may have a wide-angled edge 120. Tapered edge 110b and wide-angled edge 120 may have a variety of angled surface configurations. As shown in FIG. 2, the angle of surface 110b is greater than the angle of wide-edge 120. In an alternative embodiment, the angles of surface 110b may be less than or equal to the angle of surface 120. Tapered-edge 110a may be a flat portion of the top-face 103 of the application tool 101, opposite the edge 110b.

FIG. 3 shows a top view of the face mask application tool 101 having a top-face surface 103 with brush portion 105 including a plurality of bristles (105y, 105z) in an elliptical configuration. The top-face surface 103 may have a variety of configurations. As shown in FIG. 3, surface 103 is flat or nearly (i.e., substantially) flat.

In an alternative embodiment, the surface 103 may have a variety of contours composed of a variety of materials. Along a proximal portion of top-face surface 103 is tapered-edge 110a. The tapered-edge 110a is designed to provide transfer of skin care product from the product container directly onto the surface of the skin without any contamination of the remaining product in the product container. The tapered-edge 110a may have a variety of configurations. In an alternative embodiment, the tapered-edge 110a may include a contoured configuration, such as a divot or bowl, in order to efficiently obtain skin care product from the product container with minimal loss of product.

FIG. 4 shows a bottom view of the face mask application tool 101 having a bottom-face surface 115 with tapered surface 110b along the proximal edge and wide-edge 120 along the distal edge. The tapered surface 110b and wide-edge 120 is angled (as shown in FIG. 2). In an alternative embodiment, the bottom-face surface 115 may have tapered-edge 110b and wide-edge 120 with different angles or no angles. The surface 115 is made of resilient material, such as silicone, and is designed for a user to grip the application tool 101 on the palm of the user.

In use, a user grasps the face mask application tool 101 with the bottom-face surface 115 facing the palm of the hand of the user. The user is able to obtain skin care product from the product container by placing the tapered-edge 110a into the product container. The tapered-edge 110a is designed to hold the skin care product on its surface. The user applies, for example uniformly, the skin care product onto the skin surface of their face, or the face or other skin surface of another person. The brush portion 105 is designed to massage at least one active ingredient of the skin care product into the skin. The brush portion may be further configured to provide a soothing sensation to the skin surface and/or a sub-surface of the user.

Upon distribution of the skin care product onto the skin and/or absorption of, for example, one or more active ingredients, excess skin care product may be removed from surface 103, surface 110b, surface 115, surface 120, or any combination thereof. To maintain the integrity of the application tool 101, excess skin care product may be removed by rinsing the tool 101 under running water in-between use.

The face mask application tool 101 is, according to an embodiment, composed of silicone material resistant to microbial contamination. The silicone material of the face mask application tool 101 is designed to ease the removal of residual skin care product or any residual dead skin (an epidermal layer) transferred onto the tool 101. In an embodiment, the tapered-edge 110a may be configured to remove excess skin care product from the skin surface of the person's face (for example, through a gentle scraping motion or the like).

A person skilled in the art will appreciate the device disclosed herein can have a variety of configurations and can be used in varying manners. Many variation and modifications will be apparent. Each of the aspects and embodiments described herein are capable of being used together, unless excluded either explicitly or clearly from the context of the embodiment or aspect.

One skilled in the art will appreciate further features and advantages of the disclosure based on the above-described embodiments. Accordingly, the invention is not to be limited by what has been particularly shown and described, except as indicated by the appended claims. All publications and references cited herein are expressly incorporated herein by reference in their entirety.

What is claimed is:

1. A device for applying skin care product to a user, comprising:
a top-face having a brush portion at a distal end and a tapered application portion at a proximal end, wherein the tapered application portion is configured to obtain the skin care product from a container and apply the skin care product to a surface of the user, wherein the brush portion is configured to massage the skin care product into the surface of the user;
a bottom-face opposite the top-face having a wide base configured to be held by the user.

2. The device of claim 1, wherein the top-face, the brush portion, and/or the bottom-face are comprised of a silicone material.

3. The device of claim 1, wherein the brush portion is further configured to provide a soothing sensation to the surface and/or a sub-surface of the user.

4. The device of claim 1, wherein the brush portion is comprised of bristles of a uniform height.

5. The device of claim 1, wherein the brush portion is comprised of bristles of varying heights.

6. The device of claim 1, wherein the tapered application portion of the top-face comprises a contoured configuration.

7. The device of claim 1, wherein the bottom-face comprises an angled, tapered edge at a proximal edge and a wide-angled edge at a distal edge.

8. The device of claim 7, wherein a remainder portion of the bottom-face is substantially flat.

9. The device of claim 1, wherein the top-face is substantially flat.

10. The device of claim 1, wherein the tapered application portion is further configured to remove excess skin care product from the surface of the user.
